(19) United States
(12) Patent Application Publication
(10) Pub. No.: US 2025/0378971 A1
(43) Pub. Date: Dec. 11, 2025

(54) NUCLEAR POWER SOURCE, NUCLEAR BATTERY ASSEMBLY, AND A METHOD OF MANUFACTURE THEREOF

(71) Applicant: Westinghouse Electric Company LLC, Cranberry Township, PA (US)

(72) Inventor: Michael D. Heibel, Broomfield, CO (US)

(73) Assignee: Westinghouse Electric Company LLC, Cranberry Township, PA (US)

(21) Appl. No.: 19/108,022

(22) PCT Filed: Aug. 31, 2023
(86) PCT No.: PCT/US2023/031678

§ 371 Date: Feb. 28, 2025

Related U.S. Application Data
(60) Provisional application No. 63/374,121, filed on Aug. 31, 2022.

(51) Int. Cl. G21H 1/02; G21G 4/06; G21H 1/10

(52) U.S. Cl. CPC G21H 1/02; G21G 4/06; G21H 1/10

(57) ABSTRACT

The present disclosure provides a nuclear power source, a nuclear battery assembly, and a method of manufacture thereof. The nuclear power source comprising a radiation source layer, a first electrical insulator layer disposed over the radiation source layer, a first casing layer disposed over the first electrical insulator layer, a first electrode in contact with the radiation source layer, and a second electrode in contact with the first casing layer. The radiation source layer comprises a composition configurable to emit beta radiation. A voltage potential is present between the first electrode and the second electrode when the radiation source layer emits beta radiation. The first electrical insulator layer has a thickness that reduces an average energy of the beta-radiation from the radiation source layer that contacts the first casing layer such that Bremsstrahlung radiation emitted when the beta-radiation reaches the first casing layer is reduced.

### CROSS-REFERENCE TO RELATED APPLICATION

This application is a U.S. National Stage Entry under 35 U.S.C. § 371 of International Patent Application No. PCT/US2023/031678, entitled “NUCLEAR POWER SOURCE, NUCLEAR BATTERY ASSEMBLY, AND A METHOD OF MANUFACTURE THEREOF,” filed Aug. 31, 2023, which claims benefit under 35 U.S.C. § 119(e) to U.S. Patent Application Ser. No. 63/374,121, filed Aug. 31, 2022, entitled “NUCLEAR POWER SOURCE, NUCLEAR BATTERY ASSEMBLY, AND A METHOD OF MANUFACTURE THEREOF,” the contents of which are hereby incorporated by reference in their entirety herein.

### BACKGROUND

Radioisotope Thermal Generators (RTGs) produce heat and utilize thermocouples to convert the heat into electricity. Plutonium-238 has typically been used in RTGs as it has a desirable half-life of 87.7 years and Plutonium-238 emits alpha radiation that decelerates rapidly in the material surrounding the Plutonium-238 to produce heat. Additionally, Plutonium-238 produces essentially no gamma radiation and the deceleration of alpha radiation produces essentially no gamma radiation, which minimizes the radiation shielding needed to allow the Plutonium-238 powered RTGs to be used in close proximity to people and/or radiation-sensitive electronics. However, using Plutonium-238 in RTGs presents challenges.

### SUMMARY

The present disclosure provides a nuclear power source comprising a radiation source layer, a first electrical insulator layer disposed over the radiation source layer, a first casing layer disposed over the first electrical insulator layer, a first electrode in contact with the radiation source layer, and a second electrode in contact with the first casing layer. The radiation source layer comprises a composition configurable to emit beta radiation. The first casing layer comprises a metal having an atomic number of 13 or less or a metal alloy having a primary metal having an atomic number of 13 or less. A voltage potential is present between the first electrode and the second electrode when the radiation source layer emits beta radiation. The first electrical insulator layer has a thickness that reduces an average energy of the beta-radiation from the radiation source layer that contacts the first casing layer such that Bremsstrahlung radiation emitted when the beta-radiation reaches the first casing layer is reduced.

It is understood that the inventions described in this specification are not limited to the examples summarized in this Summary. Various other aspects are described and exemplified herein.

### BRIEF DESCRIPTION OF THE DRAWING

The features and advantages of the examples, and the manner of attaining them, will become more apparent, and the examples will be better understood by reference to the following description of examples taken in conjunction with the accompanying drawing, wherein:

FIG. 1 is a partial cross section of an example of a nuclear power source according to the present disclosure;

FIG. 2 is a details viewed of area A in FIG. 1;

FIG. 3 is a partial cross section of an example of a nuclear battery assembly according to the present disclosure; and

FIG. 4 is a flow chart illustrating an example of a method of manufacture of a nuclear power source according to the present disclosure.

The exemplifications set out herein illustrate certain examples, in one form, and such exemplifications are not to be construed as limiting the scope of the examples in any manner.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present invention is defined solely by the claims. The features illustrated or described in connection with one exemplary aspect may be combined with the features of other aspects. Such modifications and variations are intended to be included within the scope of the present invention.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

Typically RTGs only generate electrical energy from thermal energy produced by the deceleration of alpha radiation from plutonium-238. However, plutonium-238 can be an undesirable fuel. Additionally, beta emitting compositions were not previously used as beta radiation can produce Bremsstrahlung radiation emissions (e.g., gamma radiation) which can be undesirable and require an undesirable large radiation shielding layer. Further, it has been difficult to increase the power density of RTGs. Accordingly, the present inventors have provided a nuclear battery that can generate electrical energy directly from beta radiation emissions without the need to first create thermal energy from the beta radiation, increase power density of RTGs, and/or reduce electrical shielding requirements. In various examples the nuclear battery can generate electrical energy directly from the beta radiation, Bremsstrahlung radiation, and thermal energy. The nuclear power source and/or nuclear battery assembly can reduce the size of a radiation shielding layer and/or can reduce the size of the casing layer by providing a controlled slow-down of beta radiation emitted of the radiation source layer.

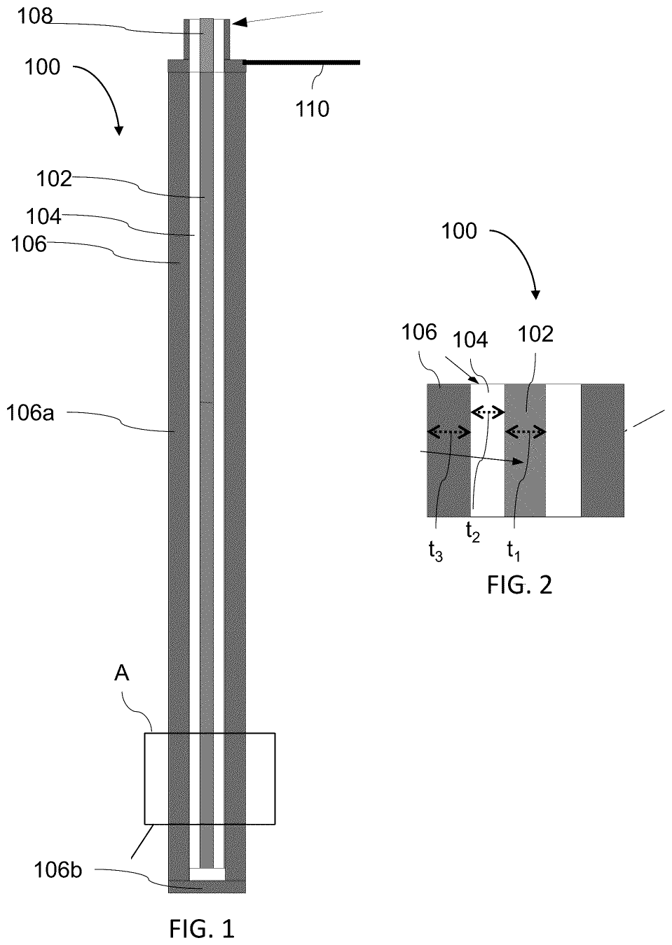

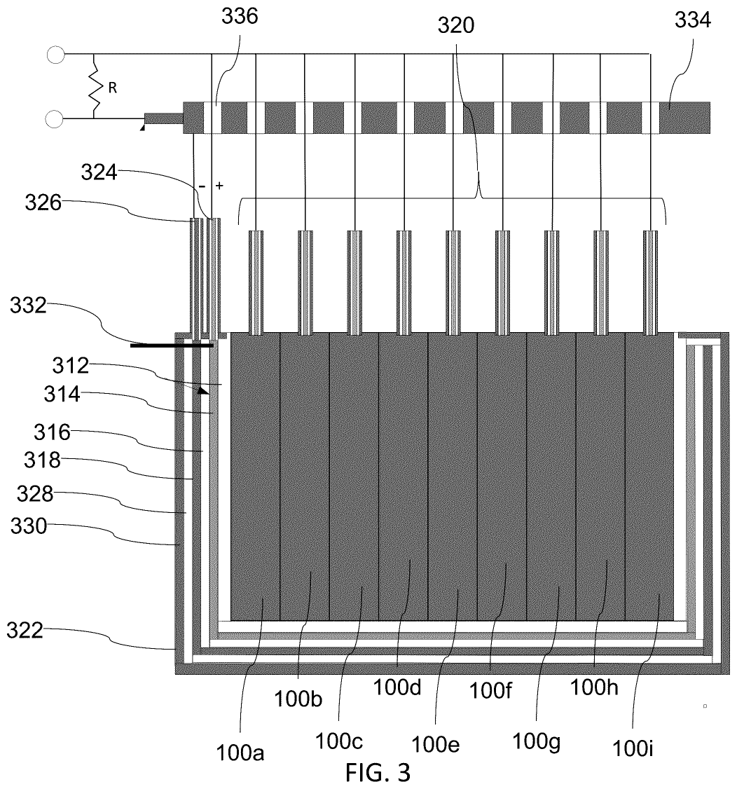

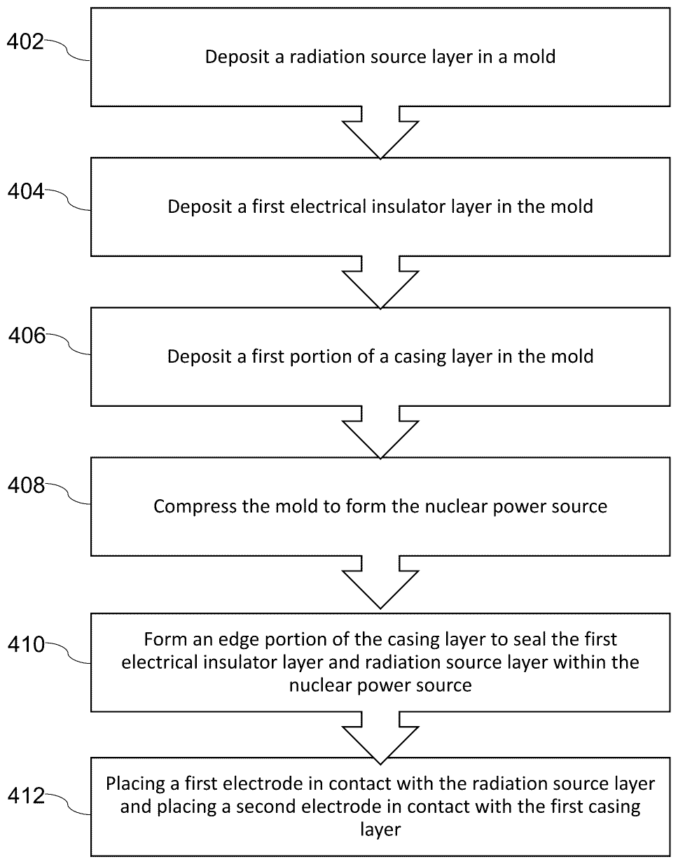

Referring to FIG. 1, an example of a nuclear power source 100 according to the present disclosure is provided. The nuclear power source 100 comprises a radiation source layer 102, a first electrical insulator layer 104, a first casing layer 106, a first electrode 108, and a second electrode 110. The nuclear power source 100 can be configured as a battery plate, a rod, or other shape. In various examples, the nuclear power source 100 can comprise a single battery plate as shown in the FIG. 1 or a nuclear battery assembly 300 can comprise multiple battery plates 100a-100i as shown in FIG. 3. In the rod shaped configuration (not shown) of the nuclear power source 100, each of the layers 102, 104, and 106 can have the vertical cross section as shown in FIG. 1. The size of the nuclear power source 100 can be controlled to produce a desired amount of electric power.

The radiation source layer 102 comprises a composition configurable to emit beta radiation. For example, the radiation source layer 102 can comprises thulium, a thulium isotope, strontium, a strontium isotope, or a combination thereof. In certain examples, the radiation source layer 102 comprises a strontium isotope that emits beta radiation, such as, for example, strontium fluoride.

The radiation source layer 102 can be plate shaped or rod shaped. The radiation source layer 102 can be produced with a thickness based on the desired amount of beta radiation to be emitted. For example, referring to FIG. 2, the radiation source layer 102 can comprise a thickness, t₃, in a range of 0.5 mm to 5 mm, such as, for example, 0.5 mm to 2 mm, or 0.75 mm to 1.5 mm. The dimensions of the radiation source layer 102 can be sized to produce a desired amount of beta radiation and thereby electric power of the nuclear power source 100.

Referring again to FIG. 1, the first electrical insulator layer 104 is disposed over the radiation source layer 102. For example, the first electrical insulator layer 104 can be in direct contact with and surround the radiation source layer 102. The first electrical insulator layer 104 can comprise a composition and thickness, t₂, suitable to provide a desired electrical resistance between the radiation source layer 102 and the first casing layer 106. For example, the thickness, t₂, can be suitable to reduce an amount of beta radiation emitted from the radiation source layer 102 that contacts the first casing layer 106 such that Bremsstrahlung radiation emitted when the beta-radiation reaches the first casing layer 106 can be reduced and thereby a thickness, t₃, of the first casing layer 106 can be reduced. Referring to FIG. 2, the thickness, t₂, can be in a range of 0.1 mm to 5 mm, such as, for example, 0.1 mm to 2 mm, 0.2 mm to 1 mm, or 0.3 mm to 0.8 mm.

Referring yet again to FIG. 1, the first electrical insulator layer 104 can comprise a metal oxide. In various examples, the first electrical insulator layer 104 can comprise magnesium oxide, aluminum oxide, diamond, or a combination thereof. For example, the first electrical insulator layer 104 can comprise magnesium oxide.

The first casing layer 106 is disposed over the first electrical insulator layer 104. For example, the first casing layer 106 can be in direct contact with and surround the first electrical insulator layer 104. The first casing layer 106 can comprise a first portion 106a and an edge portion 106b sealing (e.g., hermetically sealing) the first electrical insulator layer 104 and the radiation source layer 102 within the first casing layer 106.

The first casing layer 106 comprises a composition and thickness configured to inhibit traversal of beta radiation (e.g., slow the beta radiation) through the first casing layer 106. For example, the first casing layer 106 can comprise a metal or a metal alloy, such as, for example, a metal with an atomic number of 13 or less, or a metal alloy having a primary metal (e.g., metal having the greatest mass percentages based on the total weight of the metal alloy) having an atomic number of 13 or less. In various examples, the first casing layer 106 can comprise aluminum, an aluminum alloy, magnesium, or a magnesium alloy. For example, the first casing layer 106 can comprise aluminum or an aluminum alloy. In examples where the first electrical insulator layer 104 has a thickness, t₂, there can be reduced Bremsstrahlung radiation produced by the first casing layer 106 due to the gradual slowing of traversal of the beta radiation through the first electrical insulator layer 104. Therefore, the thickness, t₃, of the first casing layer 106 can be reduced. For example, referring to FIG. 2, the thickness, t₃, of the first casing layer 106 can be in a range of 0.1 mm to 5 mm, such as, for example, 0.5 mm to 3 mm, 1 mm to 2 mm, or 1.1 mm to 1.8 mm.

Referring again to FIG. 1, the first electrode 108 is in contact with the radiation source layer 102. The first electrode 108 can be electrically insulated from the first casing layer 106 and any other electrically conductive layers in the nuclear power source 100 besides the radiation source layer 102. In various examples, the first electrode 108 is configured as a positive electrode.

The second electrode 110 is in contact with the first casing layer 106. The second electrode 110 can be electrically insulated from the radiation source layer 102 and in a nuclear battery assembly from the radiation shielding layer. In various examples, the second electrode 110 is configured as a negative electrode. Forming a circuit between the electrodes 108 and 110 causes electricity to flow between the electrodes 108 and 110 when the radiation source layer 102 emits beta radiation.

The beta radiation emitted by the radiation source layer 102 can be directly used to produce electrical energy without the need to first produce thermal energy. For example, the beta radiation emitted by the radiation source layer 102 can traverse through the first electrical insulator layer 104 to the first casing layer 106. The traversal of the beta radiation can create a voltage potential between the radiation source layer 102 and the first casing layer 106. For example, the beta radiation can comprise electrons which can be transferred to the first casing layer 106 and thereby causing electrical output through the second electrode 110.

The thickness, t₂, can create a desirable electrical resistance between the radiation source layer 102 and the first casing layer 106 while enabling traversal of the beta radiation through the first electrical insulator layer 104 such that a voltage potential can be created. Thus, due to the contact between the first electrode 108 and the radiation source layer 102 and the contact between the second electrode 110 and the first casing layer 106, a voltage potential is present between the first electrode 108 and the second electrode 110 when the radiation source layer 102 emits beta radiation. Alpha radiation emitters that are used in typical RTGs would not be able to achieve a desirable voltage potential since alpha radiation only travels very short distances in solid materials.

Referring to FIG. 3, an example of a nuclear battery assembly 300 according to the present disclosure is provided. The nuclear battery assembly 300 can comprise a source assembly 320, a container 322, and a lid 334. The source assembly 320 can be formed from a single nuclear power source 100a, at least two nuclear power sources 100a-100b, at least three nuclear power sources 100a-100c, at least four nuclear power sources 100a-100d, or at least nine nuclear power sources 100a-100i as illustrated in FIG. 3. Each nuclear power source 100a-100i can be the same or different and can be configured according to nuclear power source 100.

The nuclear power sources 100a-100i within the source assembly 320 can be connected in a parallel electrical circuit such that the total current output by the nuclear battery assembly 300 can be a sum of the nuclear power sources 100a-100i. The nuclear power sources 100a-100i can be adjacent to each other and the first casing layer 106 of each nuclear power source 100a-100i can be in contact with each other thereby forming an electrical connection between the second electrodes 110 of each nuclear power source 100a-100i.

The container 322 can comprise a second electrical insulator layer 312, a radiation shielding layer 314, a third electrical insulator layer 316, a second casing layer 318, a third electrode 324, and a fourth electrode 326.

The second electrical insulator layer 312 is disposed over the source assembly 320. For example, the second electrical insulator layer 312 can be in direct contact with and surround the source assembly 320. The second electrical insulator layer 312 can comprise a composition and thickness suitable to provide a desired electrical resistance between the source assembly 320 and the radiation shielding layer 314 such that the radiation shielding layer 314 is inhibited from interfering with the electric potential generated within the source assembly 320. For example, the second electrical insulator layer 312 can be configured substantially according to the first electrical insulator layer 104. The second electrical insulator layer 312 can be thermally conductive. Thus, heat generated in the source assembly 320 by inhibition traversal of beta radiation be conducted to the radiation shielding layer 314 or other layer.

The radiation shielding layer 314 is disposed over the second electrical insulator layer 312. For example, the radiation shielding layer 314 can be in direct contact with and surround the second electrical insulator layer 312. The radiation shielding layer 314 can comprise a composition and thickness suitable to inhibit Bremsstrahlung radiation (e.g., gamma radiation) from traversing through the radiation shielding layer 314. For example, the radiation shielding layer 314 can comprise a metal or metal alloy. In various examples, the radiation shielding layer 314 can comprise tungsten, a tungsten alloy, iron, an iron alloy (e.g., stainless steel), uranium, a uranium alloy, or a uranium compound. For example, the radiation shielding layer 314 can comprise tungsten or a tungsten alloy. The radiation shielding layer 314 can be in thermal communication with the source assembly 320. The radiation shielding layer 314 can produce thermal energy by inhibiting additional beta radiation and/or Bremsstrahlung radiation emissions from the source assembly 320 from traversing through the radiation shielding layer 314.

Utilizing a source assembly 320 that does not comprise individual radiation shielding layers around each of the nuclear power sources 100a-100i can enables a reduction in size and weight of the nuclear battery assembly 300. The radiation shielding layer 314 can capture emitted Bremsstrahlung radiation from the source assembly 320. The beta radiation from one nuclear power source 100a-100i can traverse into a different nuclear power source 100a-100i and interact with the first casing layer 106 of the different nuclear power source 100a-100i thereby producing electricity and optionally Bremsstrahlung radiation emissions. The Bremsstrahlung radiation emissions can then be used by the container 322 to produce electricity.

The third electrical insulator layer 316 is disposed over the radiation shielding layer 314. For example, the third electrical insulator layer 316 can be in direct contact with and surround the radiation shielding layer 314. The third electrical insulator layer 316 can comprise a composition and thickness suitable to provide a desired electrical resistance between the radiation shielding layer 314 and the second casing layer 318. For example, the third electrical insulator layer 316 can be configured substantially according to the first electrical insulator layer 104. The third electrical insulator layer 316 can be thermally conductive. Thus, heat generated at the radiation shielding layer 314 can be conducted from the radiation shielding layer 314 to the second casing layer 318.

The second casing layer 318 is disposed over the third electrical insulator layer 316. For example, the second casing layer 318 can be in direct contact with and surround the third electrical insulator layer 316. The second casing layer 318 can be configured substantially according to the first casing layer 106. For example, the second casing layer 318 can comprise a metal or a metal alloy, such as, for example, a metal with an atomic number of 13 or less, or a metal alloy having a primary metal having an atomic number of 13 or less.

Referring again to FIG. 3, the third electrode 324 is in contact with the radiation shielding layer 314. The third electrode 324 can be electrically insulated from the second casing layer 318 and any other electrically conductive layers in the nuclear battery assembly 300 besides the radiation shielding layer 314 and the radiation source layer 102. The third electrode 324 is in electrical communication with the first electrode 108 of each of the nuclear power sources 100a-100i. In various examples, the third electrode 324 is configured as a positive electrode.

The fourth electrode 326 is in contact with the second casing layer 318. The fourth electrode 326 is electrically insulated from the radiation shielding layer 314 and the radiation source layer 102. In various examples, the fourth electrode 326 is configured as a negative electrode. Forming a circuit between the electrodes 324 and 326 causes electricity to flow between the electrodes 324 and 326 when the radiation source layer 102 emits beta radiation. The fourth electrode 326 is in electrical communication with the second electrode 110 of each of the nuclear power sources 100a-100i. For example, the third electrode 324 and the fourth electrode 326 can be connected in a parallel electrical circuit with the source assembly 320 such that the total current output by the nuclear battery assembly 300 can be a sum of the source assembly 320 and the container 322.

In various examples, the container 322 further comprises a fourth electrical insulator layer 328 disposed over the second casing layer 318 and a casing layer 330 disposed over the fourth electrical insulator layer 328. For example, the fourth electrical insulator layer 328 can be in direct contact with and surround the second casing layer 318 and the casing layer 330 can be in direct contact with and surround the fourth electrical insulator layer 328. The fourth electrical insulator layer can be configured substantially according to the first electrical insulator layer 104 and the third casing layer 330 can be configured substantially according to the first casing layer 106. For example, the third casing layer 330 can comprise a metal or a metal alloy, such as, for example, a metal with an atomic number of 13 or less, or a metal alloy having a primary metal having an atomic number of 13 or less.

The lid 334 can be configured to seal the source assembly 320 within the container 322. The lid 334 can comprise a composition according to the casing layer 106 and can comprise openings 336 for the first electrodes 106 of each nuclear power source 100a-100i to pass through or otherwise provide an electrical connection for the first electrodes 108 separate from the second electrodes 110.

The nuclear battery assembly 300 can comprise a thermal energy harvesting device 332 configured to convert thermal energy into electrical energy. The thermal energy harvesting device 332 can be in physical contact with a portion of the container 322, such as, for example, the radiation shielding layer 314. The thermal energy harvesting device 332 can be configured to receive thermal energy from the radiation shielding layer 314 and convert the thermal energy into electrical energy. For example, the thermal energy harvesting device 332 can comprise a thermocouple. In various examples, the thermal energy from the radiation shielding layer 314 can be harvested in a manner used by typical RTGs.

In various examples, the container 322 may comprise a thermal insulation layer, which can comprise fiberglass, silica, carbon, other thermally insulating materials, and combinations thereof.

As described herein, the nuclear battery assembly 300 can generate electrical energy directly from the emission of beta radiation from the radiation source layer 102 to the casing layer 106 and from the emission of Bremsstrahlung radiation from the casing layer 106 to the radiation shielding layer 314 without having to harvest thermal energy. Additionally, the nuclear battery assembly 300 can generate electrical energy by converting thermal energy into electrical energy utilizing the thermal energy harvesting device 332. The nuclear battery assembly 300 can be configured to output at least 0.1 watt per cubic centimeter of volume of the nuclear battery assembly 300 (watt/cm³) from the electrodes, 108, 110, 324, and 326, such as, for example, at least 0.5 watt/cm³, at least 1 watt/cm³, at least 2 watt/cm³, at least 10 watts/cm³, at least 20 watts/cm³, or at least 50 watt/cm³.

The nuclear battery assembly 300 can be used in variety of applications where a substantially constant power source is desired. The nuclear battery assembly 300 can be used to power computers and/or communication devices of military equipment, unmanned vehicles such as planes, submarines, drones, and/or spacecraft, or civil applications such as electric cars to provide longer driving range by powering auxiliary functions such as interior heating or cooling.

Powering unmanned vehicles can also allow these vehicles to operate on conditions that are not normally achievable. Since the nuclear battery assembly 300 does not need air (e.g., oxygen) as opposed to currently used combustion engines to power, vehicles can travel at higher altitudes and/or at colder temperatures.

The present disclosure also provides a method for manufacturing a nuclear power source. In reference to FIG. 4, the method comprises depositing a radiation source layer 102 in a mold at step 402, depositing a first electrical insulator layer 104 in the mold at step 404, and depositing a first portion 106a of a first casing layer 106 in the mold at step 406. The layers can be deposited in varying order as long as the radiation source layer 102 is electrically insulated from the first portion 106a of the first casing layer 106 by the first electrical insulator layer 104 in the mold. In various examples, the first portion 106a of the first casing layer 106 can be deposited as a sheet material (e.g., an aluminum or aluminum alloy sheet material), the first electrical insulator layer 104 can be deposited as a powder or sheet material (e.g., metal oxide powder or metal oxide sheet material), and the radiation source layer 102 can be deposited as a slurry, a solution, or a powder (e.g., slurry of a strontium radioisotope).

The mold is compressed to form the nuclear power source 100 comprising the radiation source layer 102, the first electrical insulator layer 104, and the first portion 106a of the first casing layer 106 at step 408. An edge portion 106b of the first casing layer 106 is formed on the nuclear power source 100 to seal (e.g., hermetically sealed) the first electrical insulator layer 104 and radiation source layer 102 within the nuclear power source 100 at step 410. For example, forming the edge portion 106b can comprise welding the edge portion 106b onto the first portion 106a, crimping the first portion 106a to form the edge portion 106b, or a combination thereof.

The method comprises placing a first electrode 108 in contact with the radiation source layer 102 and placing a second electrode 110 in contact with the first casing layer 106 at step 412.

To manufacture the nuclear battery assembly 300, one or two or more of the nuclear power sources 100a-100i can be stacked adjacent to one another to form a source assembly 320. The container 322 can be separately manufactured from the source assembly 320 and the source assembly 320 can be positioned within the container 322 and sealed within the container 322 by the lid 334.

Various aspects of the invention according to the present disclosure include, but are not limited to, the aspects listed in the following numbered clauses.

Clause 1. A nuclear power source comprising:
a radiation source layer, wherein the radiation source layer comprises a composition configurable to emit beta radiation;
a first electrical insulator layer disposed over the radiation source layer;
a first casing layer disposed over the first electrical insulator layer, wherein the first casing layer comprises a metal having an atomic number of 13 or less or a metal alloy having a primary metal having an atomic number of 13 or less;
a first electrode in contact with the radiation source layer; and
a second electrode in contact with the first casing layer, wherein a voltage potential is present between the first electrode and the second electrode when the radiation source layer emits beta radiation,
wherein the first electrical insulator layer has a thickness that reduces an average energy of the beta-radiation emitted from the radiation source layer that contacts the first casing layer such that Bremsstrahlung radiation emitted when the beta-radiation reaches the first casing layer is reduced.

Clause 2. The nuclear power source of clause 1, wherein the radiation source layer comprises thulium, a thulium isotope, strontium, a strontium isotope, or a combination thereof.

Clause 3. The nuclear power source of any one of clauses 1-2, wherein the first electrical insulator layer comprises a metal oxide, diamond, or a combination thereof.

Clause 4. The nuclear power source of any one of clauses 1-3, wherein the first casing layer comprises aluminum, an aluminum alloy, magnesium, or a magnesium alloy.

Clause 5. The nuclear power source of any one of clauses 1-4, wherein the radiation source layer comprises strontium fluoride, the first casing layer comprises aluminum or an aluminum alloy, and the first electrical insulator layer comprises magnesium oxide.

Clause 6. The nuclear power source of any one of clauses 1-5, wherein the first thickness is in a range of 0.1 mm to 5 mm, and the second thickness is in a range of 0.1 mm to 5 mm, and wherein the radiation source layer has a third thickness in a range of 0.5 mm to 5 mm.

Clause 7. A nuclear battery assembly comprising:
the nuclear power source according to any of clauses 1-6; and
a container comprising:
   a second electrical insulator layer disposed over the first casing layer of the nuclear power source;
   a radiation shielding layer disposed over the second electrical insulator layer;
   a third electrical insulator layer disposed over the radiation shielding layer;
   a second casing layer disposed over the third electrical insulator layer;
   a third electrode in contact with the radiation shielding layer, wherein the third electrode is in electrical communication with the first electrode; and
   a fourth electrode in contact with the second casing layer, wherein the fourth electrode is in electrical communication with the second electrode.

Clause 8. A nuclear battery assembly comprising:
at least two nuclear power sources according to any of clauses 1-6, wherein the at least two nuclear power source form a source assembly and are connected in a parallel electrical circuit; and
a container comprising:
   a second electrical insulator layer disposed over the source assembly;
   a radiation shielding layer disposed over the second electrical insulator layer;
   a third electrical insulator layer disposed over the radiation shielding layer;
   a second casing layer disposed over the third electrical insulator layer;
a third electrode in contact with the radiation shielding layer, wherein the third electrode is in electrical communication with the first electrode of each of the at least two nuclear power sources; and
a fourth electrode in contact with the second casing layer, wherein the fourth electrode is in electrical communication with the second electrode of each of the at least two nuclear power sources.

Clause 9. The nuclear battery assembly of any of clauses 7-8, wherein the container further comprises
a fourth insulator layer disposed over the second casing layer; and
a third casing layer disposed over the fourth insulator layer.

Clause 10. The nuclear battery assembly of any of clauses 7-9, wherein the radiation shielding layer comprises tungsten, a tungsten alloy, iron, an iron alloy, uranium, or a uranium alloy.

Clause 11. The nuclear battery assembly of any of clauses 7-10, wherein the at least two nuclear power sources are adjacent to each other and the first casing layer of adjacent power sources are in contact with each other.

Clause 12. The nuclear battery assembly of any of clauses 7-11, wherein the radiation source layer is plate shaped or rod shaped.

Clause 13. The nuclear battery assembly of any of clauses 7-12, further comprising a thermal energy harvesting device configured to convert thermal energy into electrical energy.

Clause 14. The nuclear battery assembly of any of clauses 7-13, wherein the first electrode is electrically insulated from the first casing layer and the second electrode is electrically insulated from the radiation source layer.

Clause 15. The nuclear battery assembly of any of clauses 7-14, wherein the nuclear battery assembly is configured to output at least 0.1 watt per cubic centimeter of volume of the nuclear battery assembly.

Clause 16. A method for manufacturing a nuclear power source, the method comprising:
depositing a radiation source layer in a mold, wherein the radiation source layer comprises a composition configurable to emit beta radiation;
depositing a first electrical insulator layer in the mold;
depositing a first portion of a first casing layer in the mold, wherein the first portion of the first casing layer comprises a metal having an atomic number of 13 or less or a metal alloy having a primary metal having an atomic number of 13 or less, wherein the radiation source layer is electrically insulated from the first portion of the first casing layer by the first electrical insulator layer in the mold;
compressing the mold to form a nuclear power source comprising the radiation source layer, the first electrical insulator layer, and the first portion of the first casing layer; and
forming an edge portion of the first casing layer on the nuclear power source to seal the first electrical insulator layer and radiation source layer within the nuclear power source.

Clause 17. The method of clause 16, wherein forming the edge portion comprises welding the edge portion onto the first portion, crimping the first portion to form the edge portion, or a combination thereof.

Clause 18. The method of any of clauses 16-17, wherein the first electrical insulator layer and radiation source layer are hermetically sealed within the nuclear power source.

Clause 19. The method of any of clauses 16-18, further comprising:
placing a first electrode in contact with the radiation source layer; and
placing a second electrode in contact with the first casing layer.

Clause 20. The method of any of clauses 16-19, wherein the first portion of the first casing layer is deposited as an aluminum or aluminum alloy sheet material, the first electrical insulator layer is deposited as a metal oxide powder or metal oxide sheet material, and the radiation source layer is deposited as a slurry, a solution, or a powder.

Various features and characteristics are described in this specification to provide an understanding of the composition, structure, production, function, and/or operation of the invention, which includes the disclosed methods and systems. It is understood that the various features and characteristics of the invention described in this specification can be combined in any suitable manner, regardless of whether such features and characteristics are expressly described in combination in this specification. The Inventors and the Applicant expressly intend such combinations of features and characteristics to be included within the scope of the invention described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of this invention have been described above for purposes of illustration, it will be evident to those skilled in the art that numerous variations of the details of the present invention may be made without departing from the invention as defined in the appended claims.

What is claimed is:

1. A nuclear power source comprising:
a radiation source layer, wherein the radiation source layer comprises a composition configurable to emit beta radiation;
a first electrical insulator layer disposed over the radiation source layer;
a first casing layer disposed over the first electrical insulator layer, wherein the first casing layer comprises a metal having an atomic number of 13 or less or a metal alloy having a primary metal having an atomic number of 13 or less;
a first electrode in contact with the radiation source layer; and
a second electrode in contact with the first casing layer, wherein a voltage potential is present between the first electrode and the second electrode when the radiation source layer emits beta radiation,
wherein the first electrical insulator layer has a thickness that reduces an average energy of the beta radiation emitted from the radiation source layer that contacts the first casing layer such that Bremsstrahlung radiation emitted when the beta radiation reaches the first casing layer is reduced.

2. The nuclear power source of claim 1, wherein the radiation source layer comprises thulium, a thulium isotope, strontium, a strontium isotope, or a combination thereof.

3. The nuclear power source of claim 1, wherein the first electrical insulator layer comprises a metal oxide, diamond, or a combination thereof.

4. The nuclear power source of claim 1, wherein the first casing layer comprises aluminum, an aluminum alloy, magnesium, or a magnesium alloy.

5. The nuclear power source of claim 1, wherein the radiation source layer comprises strontium fluoride, the first casing layer comprises aluminum or an aluminum alloy, and the first electrical insulator layer comprises magnesium oxide.

6. The nuclear power source of claim 1, wherein the first electrical insulator layer has a first thickness in a range of 0.1 mm to 5 mm, and the first casing layer has a second thickness in a range of 0.1 mm to 5 mm, and wherein the radiation source layer has a third thickness in a range of 0.5 mm to 5 mm.

7. A nuclear battery assembly comprising:
the nuclear power source of claim 1; and
a container comprising:
a second electrical insulator layer disposed over the first casing layer of the nuclear power source;
a radiation shielding layer disposed over the second electrical insulator layer;
a third electrical insulator layer disposed over the radiation shielding layer;
a second casing layer disposed over the third electrical insulator layer;
a third electrode in contact with the radiation shielding layer, wherein the third electrode is in electrical communication with the first electrode; and
a fourth electrode in contact with the second casing layer, wherein the fourth electrode is in electrical communication with the second electrode.

8. A nuclear battery assembly comprising:
at least two nuclear power sources according to claim 1, wherein the at least two nuclear power source form a source assembly and are connected in a parallel electrical circuit; and
a container comprising:
a second electrical insulator layer disposed over the source assembly;
a radiation shielding layer disposed over the second electrical insulator layer;
a third electrical insulator layer disposed over the radiation shielding layer;
a second casing layer disposed over the third electrical insulator layer;
a third electrode in contact with the radiation shielding layer, wherein the third electrode is in electrical communication with the first electrode of each of the at least two nuclear power sources; and
a fourth electrode in contact with the second casing layer, wherein the fourth electrode is in electrical communication with the second electrode of each of the at least two nuclear power sources.

9. The nuclear battery assembly of claim 8, wherein the container further comprises
a fourth insulator layer disposed over the second casing layer; and
a third casing layer disposed over the fourth insulator layer.

10. The nuclear battery assembly of claim 8, wherein the radiation shielding layer comprises tungsten, a tungsten alloy, iron, an iron alloy, uranium, or a uranium alloy.

11. The nuclear battery assembly of claim 8, wherein the at least two nuclear power sources are adjacent to each other and the first casing layer of adjacent power sources are in contact with each other.

12. The nuclear battery assembly of claim 8, wherein the radiation source layer is plate shaped or rod shaped.

13. The nuclear battery assembly of claim 8, further comprising a thermal energy harvesting device configured to convert thermal energy into electrical energy.

14. The nuclear battery assembly of claim 8, wherein the first electrode is electrically insulated from the first casing layer and the second electrode is electrically insulated from the radiation source layer.

15. The nuclear battery assembly of claim 8, wherein the nuclear battery assembly is configured to output at least 0.1 watt per cubic centimeter of volume of the nuclear battery assembly.

16. A method for manufacturing a nuclear power source, the method comprising:
depositing a radiation source layer in a mold, wherein the radiation source layer comprises a composition configurable to emit beta radiation;
depositing a first electrical insulator layer in the mold;
depositing a first portion of a first casing layer in the mold, wherein the first portion of the first casing layer comprises a metal having an atomic number of 13 or less or a metal alloy having a primary metal having an atomic number of 13 or less, wherein the radiation source layer is electrically insulated from the first portion of the first casing layer by the first electrical insulator layer in the mold;
compressing the mold to form a nuclear power source comprising the radiation source layer, the first electrical insulator layer, and the first portion of the first casing layer; and
forming an edge portion of the first casing layer on the nuclear power source to seal the first electrical insulator layer and radiation source layer within the nuclear power source.

17. The method of claim 16, wherein forming the edge portion comprises welding the edge portion onto the first portion, crimping the first portion to form the edge portion, or a combination thereof.

18. The method of claim 16, wherein the first electrical insulator layer and radiation source layer are hermetically sealed within the nuclear power source.

19. The method of claim 16, further comprising:
placing a first electrode in contact with the radiation source layer; and
placing a second electrode in contact with the first casing layer.

20. The method of claim 16, wherein the first portion of the first casing layer is deposited as an aluminum or aluminum alloy sheet material, the first electrical insulator layer is deposited as a metal oxide powder or metal oxide sheet material, and the radiation source layer is deposited as a slurry, a solution, or a powder.
